(19) United States
(12) Patent Application Publication
(10) Pub. No.: US 2011/0219766 A1
(43) Pub. Date: Sep. 15, 2011

(54) Arrangement and Control Method for Supplying Fresh Gas to a Turbocharged Internal Combustion Engine

(75) Inventors: Manuel MARX, Weichs (DE); Gerd Fritsch, Muenchen (DE); Huba Nemeth, Budapest (HU)

(73) Assignee: KNORR-BREMSE Systeme fuer Nutzfahrzeuge GmbH, Muenchen (DE)

(21) Appl. No.: 13/052,555

(22) Filed: Mar. 21, 2011

Related U.S. Application Data
(63) Continuation of application No. PCT/EP2009/006730, filed on Sep. 17, 2009.

(30) Foreign Application Priority Data
Sep. 22, 2008 (DE) 10 2008 048 366.4

(51) Int. Cl. F02B 37/00; F02B 37/12; F02M 25/07

(52) U.S. Cl. 60/599; 60/605.1; 60/605.2

(57) ABSTRACT

An arrangement for supplying fresh gas to a turbocharged internal combustion engine having an intake line and an exhaust gas line, includes an exhaust gas turbocharger having a compressor impeller for compressing fresh gas and feeding the compressed fresh gas to the internal combustion engine, and having a drive impeller for driving the internal combustion engine with exhaust gas for driving the compressor impeller. The arrangement also includes a compressed air supply system for the controlled supply of compressed fresh gas or compressed air to the internal combustion engine. The compressed air supply system is connected via a charge air intake to the compressor impeller, via an outlet to the intake line, and via a compressed air inlet to a compressed air source. The compressor impeller of the exhaust gas turborcharger is composed completely of partially of steel or a steel alloy.

### CROSS-REFERENCE TO RELATED APPLICATIONS

This application is a continuation of PCT International Application No. PCT/EP2009/006730, filed Sep. 17, 2009, which claims priority under 35 U.S.C. §119 from German Patent Application No. DE 10 2008 048 366.4, filed Sep. 22, 2008, the entire disclosures of which are herein expressly incorporated by reference.

### BACKGROUND AND SUMMARY OF THE INVENTION

The invention relates to an arrangement for supplying fresh gas to a turbocharged internal combustion engine. The invention also relates to a method for controlling an arrangement of this kind.

Internal combustion engines, such as diesel engines, are very frequently fitted with exhaust gas turbochargers. A drive rotor driven by an exhaust gas flow from the internal combustion engine drives a compressor impeller in order to compress fresh gas. Compressor impellers are produced from aluminum or aluminum alloys. The reason for this is, in particular, the relatively low density and hence also low mass moment of inertia, this being important especially in the case of torque demands, i.e. when the internal combustion engine is accelerated, since the exhaust gas turbocharger cannot deliver sufficient air in all operating states of the internal combustion engine and thus produce an adequate intake pressure.

By way of example, piston engines, such as diesel engines, with an exhaust gas turbocharger have an operating state during acceleration referred to as “turbo lag”, for example. Here, the internal combustion engine responds to acceleration with an increase in engine speed only after a certain delay, in which no exhaust gas energy, that is to say also insufficient exhaust gas pressure, is available to drive the exhaust gas turbocharger. Hence, there is no compressed intake air with an appropriate intake pressure available. During this acceleration process, the exhaust gas mass flow has to accelerate the turbocharger until the latter can build up its full charge pressure. The time required to achieve the maximum charge pressure or charge air pressure depends decisively on the inertia of the impeller/rotor (compressor impeller, drive rotor or turbine) of the turbocharger.

Proposed solutions for bridging this “turbo lag” have been put forward, in which compressed air, from a reservoir fed by an air compressor for example, is passed into the internal combustion engine in a controlled manner in order to cover the intake air requirement of the internal combustion engine when the requirement is increased. This is accomplished by way of a fresh gas supply device which is arranged between the compressor of the turbocharger, or a charge air cooler positioned downstream, and the intake line and is described in WO 2006/089779 A1, to which reference is made in this connection.

Here, the term “fresh gas” is intended to refer to intake air. This should be distinguished from compressed air, which is produced separately, by means of a compressor for example, and is stored in a reservoir. Charge air is the intake air compressed by the turbocharger or the fresh gas compressed by the latter.

Owing to current conditions, especially impending emissions legislation (e.g. EU5; EU6 etc.), further steps are necessary. One of these is external exhaust gas recirculation (EGR) as a key means of meeting the NOx emission limits, in particular. This is based on the effect that cooled exhaust gas is fed back to the engine. Exhaust gas is thus inert and does not take part in combustion. As a result, there is a drop in the combustion temperature, this and the excess of oxygen being the decisive factor for the formation of NOx. Here, the following relationship applies: the higher the EGR rates, the lower is the combustion temperature and the lower are the NOx emissions. EGR rates of up to 50% are currently being discussed. In order to achieve these rates in combination with the same quantity of fresh air/gas, significantly higher charge pressures (e.g. up to 4.5 bar) are necessary. As a result, significantly higher forces and temperatures arise at the compressor impeller of the turbocharger than is the case with current internal combustion engines. The disadvantage here is that aluminum can no longer withstand these stresses. As a solution here, compressor impellers made of titanium have been developed, and these are already in series production for vehicles subject to extreme stresses. Since titanium is very costly as a material, there is a conflict here in terms of fulfillment of purpose based on legal requirements and costs. Another disadvantage may be regarded as the fact that overloaded compressor impellers made of aluminum and also those made of titanium are potentially one of the most frequent causes of turbocharger failure.

There is therefore needed an improved arrangement for supplying fresh gas to an internal combustion engine and a method for controlling an arrangement of this kind, in which the above disadvantages are eliminated or significantly mitigated and further advantages are created.

In order to meet this and other needs, an arrangement is provided for supplying fresh gas to a turbocharged internal combustion engine having an intake line and an exhaust gas line. The arrangement includes an exhaust gas turbocharger having at least one compressor impeller for compressing fresh gas and feeding the compressed fresh gas to the internal combustion engine, at least one drive rotor for driving, by way of exhaust gas from the internal combustion engine, the compressor impeller, and a compressed air supply system for the controlled supply of compressed fresh gas or compressed air to the internal combustion engine. The compressed air supply system is connected by way of a charge air inlet to the compressor impeller, by way of an outlet to the intake line and by way of a compressed air inlet to a compressed air source. The compressor impeller is composed completely or partially of steel or a steel alloy. The at least one compressor impeller of the exhaust gas turbocharger is preferably made entirely of steel.

Although a compressor impeller made of steel has a higher mass moment of inertia and would thus delay acceleration of the exhaust gas turbocharger given an increased torque demand, there is the surprising effect, in combination with the compressed air supply system, that the conflict described above can be resolved. Through controlled injection or supply of compressed air into the intake line of the internal combustion engine in the event of an increased torque demand, the compressed air supply system reduces “turbo lag” almost completely. This makes it possible to use steel for a compressor impeller with a relatively high mass moment of inertia. It is thus possible to dispense with aluminum or titanium as a material with the disadvantages described above. This also makes it possible to exploit the functional advantage of steel compressor impellers since the higher mass moment of inertia has significant advantages for a gear change. During a shift operation, an aluminum or titanium compressor impeller decelerates significantly more than a compressor impeller made of steel. From this, it follows that the compressor impeller made of aluminum or titanium requires a much longer time than the compressor impeller made of steel to reach the optimum speed of rotation in the next transmission ratio. An advantageous fuel saving is also obtained at the same time.

Another advantage of the compressor impeller made of steel is that it is significantly more robust. This in turn allows higher speeds of rotation and higher pressure ratios of the turbocharger. Moreover, it may be possible to reduce the number of charging stages required (e.g. reduction from a two-stage charger to a single-stage charger). In this way, further costs, weight and installation space can be saved.

In a preferred embodiment, the compressed air supply system is constructed with valves for the controlled supply of compressed air to the internal combustion engine if a pressure of the fresh gas compressed by the compressor impeller falls below a previously defined value in at least one specified operating state of the internal combustion engine. For this purpose, the valves can be controlled by a control device of the compressed air supply system. However, it is also possible for the arrangement to have a control device for controlling the compressed air supply system and for determining operating parameters of the exhaust gas turbocharger. Naturally, it is possible in this process to use the operating parameters of an engine control system which are available in the vehicle. It is also contemplated that a control system of this kind could be integrated into the engine control system.

By way of example, the compressed air source can have a compressed air reservoir and a compressed air compressor which feeds the latter. Other compressed air sources, such as an electric compressed air compressor without a reservoir, are possible.

The arrangement can have a charge air cooler, which is arranged between the compressor impeller of the exhaust gas turbocharger and the compressed air supply system, and can also have an exhaust gas recirculation system.

A method according to the invention for controlling the arrangement described above includes the steps of: determining the respective operating parameters of the internal combustion engine and of an exhaust gas turbocharger by a control device and/or an engine control system; supplying compressed air to the internal combustion engine by way of a compressed air supply system controlled by the control device if a charge air pressure of the exhaust gas turbocharger is below a pressure value required according to the respective operating parameters determined; or supplying compressed air from the exhaust gas turbocharger to the internal combustion engine.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic representation of an internal combustion engine with an exemplary arrangement according to the invention for supplying fresh gas; and

FIG. 2 is a graphical representation of engine torques.

### DETAILED DESCRIPTION OF THE DRAWINGS

Identical components or functional units operating in the same way are indicated by identical reference signs in the figures.

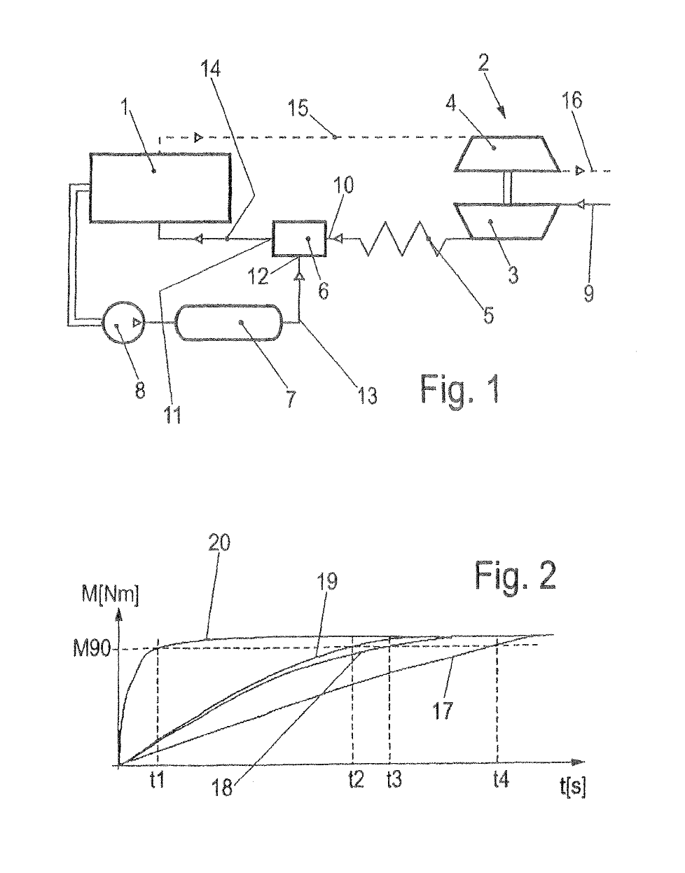

FIG. 1 illustrates a schematic representation of an internal combustion engine 1, the exhaust gas line 15 of which is coupled to a drive rotor 4 of an exhaust gas turbocharger 2. The exhaust gas turbocharger 2 has a compressor impeller 3, which is coupled to the drive rotor 4 for rotation in common. The compressor impeller 3 compresses fresh gas from a fresh gas inlet 9 in order to increase an intake pressure in an intake line 14 for the internal combustion engine 1, thereby achieving an acceleration behavior of the vehicle with the internal combustion engine 1 and a reduction in energy consumption, for example. The compressor impeller 3 is driven by the drive rotor 4, which is, for example, a turbine that is driven by the exhaust gas of the internal combustion engine 1 and, for this purpose, is arranged in the exhaust gas line 15 upstream of an exhaust gas outlet 16.

Before the intake air compressed by the compressor impeller 3 passes into the internal combustion engine 1 as charge air, it is first of all passed through a charge air cooler 5 in this illustrative embodiment. This cooler 5 is necessary in order to cool the charge air, which has heated up during the high compression. A compressed air supply system 6 is inserted between the charge air cooler 5 and the intake line 14. It is connected by means of a charge air inlet 10 to the charge air cooler 5 and by means of an outlet 11 to the intake line 14. As stated above, this compressed air supply system 6 is described in detail in WO 2006/089779 A1 and is explained only briefly here. Between the charge air inlet 10 and the outlet 11 there is a flap element, which is adjustable. Moreover, a compressed air inlet 12 is connected by means of the outlet 11 and via a valve and a compressed air line 13 to a compressed air source, which in this case is a compressed air reservoir 7 fed by a compressed air compressor 8 driven by the internal combustion engine 1.

A control device (not shown) is used to control the valve (likewise not shown) and the flap element. Here, it is also connected to pressure sensors (likewise not illustrated) in the outlet 11 and the charge air inlet 10. In this way, it is possible, in this example, for a torque demand in the event of a “kickdown” to be detected. In this case, the valve opens the connection for compressed air from the compressed air inlet 12 to the outlet 11. Before this happens, the controlled flap element is closed, ensuring that the compressed air is prevented from flowing into the exhaust gas turbocharger 2 via the charge air inlet 10 counter to the intake direction and, instead, is directed via the outlet 11 and flows into the intake line 14. When ending the supply of compressed air, this flap element is reopened and the valve leading to the compressed air line 13 is closed. At this time, the charge air pressure provided by the exhaust gas turbocharger 2 is once again sufficient.

An operating state of the internal combustion engine and of the turbocharger (here the charge air pressure of the latter) is determined, this also being possible in a manner other than that described. If the charge air pressure is below a required value when there is a torque demand, compressed air is supplied directly to the internal combustion engine 1 in order to make up for the “turbo lag”. As soon as the turbocharger 2 is generating sufficient charge air pressure, the compressed air supply is interrupted, and the compressor impeller 3 of the turbocharger 2 is once again used as the charge air supplier. Here, the compressed air supply can bridge the longer run-up time of a steel compressor impeller 3.

In this connection, FIG. 2 shows a graphical representation illustrating an engine torque of the internal combustion engine 1 against time t for various compressor impellers 3 made of different materials in different combinations of arrangements for supplying fresh gas to the internal combustion engine 1.

Curve 17 represents a first engine torque profile 17, where a compressor impeller 3 made of steel is used and there is no arrangement according to the invention with a compressed air supply system 6. A 90% engine torque M90 is reached only at a time t4. Before this time t4, there is a time t3, at which a second engine torque profile 18 is achieved by a compressor impeller made of titanium, likewise without the arrangement according to the invention with a compressed air supply system 6. Without the arrangement according to the invention with a compressed air supply system 6, an even earlier time t2 for reaching the 90% engine torque M90 is achieved by means of a compressor impeller 3 made of aluminum, with a third engine torque profile 19. If the arrangement according to the invention with a compressed air supply system 6 is now used simultaneously with a compressor impeller 3 made of steel, the fourth engine torque profile 20 with the earliest time t1 for reaching the 90% engine torque is obtained, despite the fact that the mass moment of inertia of the compressor impeller 3 is significantly higher than that of the other, prior art impellers. With this fourth engine torque profile 20, the compressor impeller 3 can in fact be made of any material, although steel is advantageous in terms of endurance, thermal stability, costs and utility in the application described above.

The invention is not limited to the illustrative embodiments described above. It can be modified within the scope of the attached claims.

Thus, a control device can also be provided with stored values in tables for different operating states of the internal combustion engine 1 and of the exhaust gas turbocharger 2 in order to set the optimum value for compressed air supply and charge air for the internal combustion engine 1 for each operating state.

Table of Reference Numerals

| | |
|---|---|
| 1 | internal combustion engine |
| 2 | exhaust gas turbocharger |
| 3 | compressor impeller |
| 4 | drive rotor |
| 5 | charge air cooler |
| 6 | compressed air supply system |
| 7 | compressed air reservoir |
| 8 | compressed air compressor |
| 9 | fresh gas inlet |
| 10 | charge air inlet |
| 11 | outlet |
| 12 | compressed air inlet |
| 13 | compressed air line |
| 14 | intake line |
| 15 | exhaust gas line |
| 16 | exhaust gas outlet |
| 17 | first engine torque profile |
| 18 | second engine torque profile |
| 19 | third engine torque profile |
| 20 | fourth engine torque profile |
| M | engine torque |
| M90 | 90% of the maximum engine torque |
| t | time |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An arrangement for supplying fresh gas to a turbocharged internal combustion engine having an intake line and an exhaust gas line, comprising:
an exhaust gas turbocharger having a compressor impeller for compressing fresh gas and feeding the compressed fresh gas to the internal combustion engine, the exhaust gas turbocharger further having a drive rotor driven by exhaust gas from the internal combustion engine, the drive rotor driving the compressor impeller;
a compressed air supply system for providing a controlled supply of compressed fresh gas or compressed air to the internal combustion engine;
wherein the compressed air supply system is coupled via a charge air inlet to the compressor impeller, via an outlet to the intake line of the internal combustion engine, and via a compressed air inlet to a compressed air source;
wherein the compressor impeller of the exhaust gas turbocharger is at least partially composed of a steel alloy.

2. The arrangement according to claim 1, wherein the compressor impeller is completely composed of the steel alloy.

3. The arrangement according to claim 1, wherein the steel alloy is steel.

4. The arranged according to claim 2, wherein the steel alloy is steel.

5. The arrangement according to claim 1, wherein the compressed air supply system comprises one or more valves for the controlled supply of compressed air to the internal combustion engine if a pressure of the compressed fresh gas from the compressor impeller falls below a defined threshold value in at least one specified operating state of the internal combustion engine.

6. The arrangement according to claim 5, wherein the one or more valves are controllable by a control device of the compressed air supply system.

7. The arrangement according to claim 5, further comprising a control device for controlling the compressed air supply system, the control device determining operating parameters of the exhaust gas turbocharger.

8. The arrangement according to claim 1, wherein the compressed air source comprises a compressed air reservoir and a compressor operatively coupled to feed the compressed air reservoir with compressed air.

9. The arrangement according to claim 1, further comprising:
a charge air cooler operatively arranged between the compressor impeller and the compressed air supply system.

10. The arrangement according to claim 1, further comprising:
an exhaust gas recirculation system operatively configured to recirculate exhaust gas to the internal combustion engine.

11. The arrangement according to claim 9, further comprising:
an exhaust gas recirculation system operatively configured to recirculate exhaust gas to the internal combustion engine.

12. A method for controlling an arrangement for supplying fresh gas to a turbocharged internal combustion engine, the method comprising the acts of:
determining respective operating parameters of the internal combustion engine and of an exhaust gas turbocharger having a steel alloy compressor impeller, the determining being carried out by at least one of a control device for a compressed air supply system and an engine control unit;
supplying compressed air to the internal combustion engine via the compressed air supply system controlled by the control unit if a charge air pressure of the exhaust gas turbocharger is below a pressure value required in accordance with the determined respective operating parameters; and
if the supplying of compressed air to the internal combustion engine via the compressed air supply system is not required, supplying compressed fresh gas from the exhaust gas turbocharger to the internal combustion engine.
